(19) United States
(12) Patent Application Publication
(10) Pub. No.: US 2015/0062978 A1
(43) Pub. Date: Mar. 5, 2015

(54) CIRCUIT FOR GENERATING REFERENCE SIGNAL FOR CONTROLLING PEAK CURRENT OF CONVERTER SWITCH, ISOLATED CONVERTER AND METHOD FOR GENERATING REFERENCE SIGNAL FOR CONTROLLING PEAK CURRENT OF CONVERTER SWITCH

(71) Applicant: SAMSUNG ELECTRO-MECHANICS CO., LTD., Gyeonggi-Do (KR)

(72) Inventors: Yun Joong LEE, Seoul (KR); Deuk Hee PARK, Suwon-si (KR); Chan Woo PARK, Suwon-si (KR); Jong Tae HWANG, Suwon-si (KR); Je Hyeon YU, Osan-si (KR); Soo Hyun MOON, Suwon-si (KR); Hye Jin LEE, Seoul (KR); Chang Seok LEE, Suwon-si (KR); Sang Hyun CHA, Seoul (KR)

(73) Assignee: SAMSUNG ELECTRO-MECHANICS CO., LTD., Gyeonggi-Do (KR)

(21) Appl. No.: 14/472,741

(22) Filed: Aug. 29, 2014

(30) Foreign Application Priority Data
Aug. 30, 2013 (KR) 10-2013-0104131

(51) Int. Cl. H02M 1/42; H05B 33/08; H02M 3/335

(52) U.S. Cl. CPC H02M 1/42; H02M 3/33523; H05B 33/0815; H02M 2001/0009
USPC 363/21.16

(57) ABSTRACT

Embodiments of the invention provide a method and a circuit for generating a reference signal for controlling a peak current of a converter switch. According to at least one embodiment, a dead-zone generator configured to form a dead-zone in an input voltage signal divided from a primary-side supply voltage of an isolated converter, and a duty ratio calculator configured to calculate a duty ratio of energy transfer to a secondary side. The circuit further includes an operator configured to generate and output a reference signal for controlling the peak current of the converter switch from a dead-zone voltage signal having the dead-zone using the duty ratio of energy transfer calculated by the duty ratio calculator.

### CROSS REFERENCE TO RELATED APPLICATION

This application claims the benefit of and priority under 35 U.S.C. §119 to Korean Patent Application No. KR 10-2013-0104131, entitled “CIRCUIT FOR GENERATING REFERENCE SIGNAL FOR CONTROLLING PEAK CURRENT OF CONVERTER SWITCH, ISOLATED CONVERTER AND METHOD FOR GENERATING REFERENCE SIGNAL FOR CONTROLLING PEAK CURRENT OF CONVERTER SWITCH,” filed on Aug. 30, 2013, which is hereby incorporated by reference in its entirety into this application.

### BACKGROUND

1. Field of the Invention

The present invention relates to a circuit for generating a reference signal for controlling a peak current of a converter switch, an isolated converter, and a method for generating a reference signal for controlling a peak current of a converter switch, and more particularly, to a circuit for generating a reference signal for controlling a peak current of a converter switch, an isolated converter, and a method for generating a reference signal for controlling a peak current of a converter switch, which generate a reference signal for controlling a peak current using a dead-zone added signal.

2. Description of the Related Art

An isolated converter transfers a current from a primary side to a secondary side by a switching operation. When a converter switch, for example, a MOSFET switch is turned on, an inductor current is increased during a turn-on period. When the inductor current is increased to reach a set peak level, the converter switch is turned off. When the converter switch is turned off, the current is transferred to the secondary side.

In a flyback or buck-boost converter type LED driver, which operates in DCM or CRM, an LED current is determined by a peak current flowing in a MOSFET, a switching cycle, and a current transfer time to a secondary side. The LED current ILED on the secondary side is a value that varies according to power and load if there is no special control. However, the higher the fluctuations of the LED current on the secondary side, the worse the line regulation and load regulation characteristics. Therefore, it is needed to suppress the secondary-side current fluctuations.

When controlling a converter switch from a primary-side sensing voltage, not controlling the converter switch by receiving a secondary-side output, a peak current of the converter switch should be controlled properly to improve a total harmonic distortion (THD) and a power factor (PF).

### RELATED ART DOCUMENTS

U.S. Patent Publication No. US 2012/0139438 (Jun. 7, 2012)
U.S. Pat. No. 7,443,700 (Oct. 28, 2008)

### SUMMARY

Accordingly, embodiments of the invention have been made to overcome the above-described problems and it is, therefore, an object of the present invention to provide a technology that controls a peak current of a converter switch using primary-side sensing information without sensing and feeding back a secondary-side output in an isolated converter, for example, a technology that controls the peak current of the converter switch by adding a dead-zone to an input voltage signal divided or detected from a primary-side supply voltage and using a signal proportional to the dead-zone added signal.

In accordance with an embodiment of the invention, there is provided a circuit for generating a reference signal for controlling a peak current of a converter switch, including a dead-zone generator for forming a dead-zone in an input voltage signal divided from a primary-side supply voltage of an isolated converter, a duty ratio calculator for calculating a duty ratio of energy transfer to a secondary side, and an operator for generating and outputting the reference signal for controlling the peak current of the converter switch from a dead-zone voltage signal having the dead-zone using the duty ratio of energy transfer calculated by the duty ratio calculator.

For example, according to at least one embodiment, the circuit for generating a reference signal for controlling a peak current of a converter switch further includes an automatic gain controller (AGC), which controls a gain of the dead-zone voltage signal output from the dead-zone generator to have a predetermined peak value and outputs the gain-controlled signal to the operator.

According to at least one embodiment, the operator includes a multiplier for multiplying the duty ratio of energy transfer, which is calculated by the duty ratio calculator, by a predetermined gain to adjust a secondary-side output, and a divider for generating and outputting the reference signal for controlling the peak current by dividing an output signal of the AGC by an output of the multiplier.

According to at least one embodiment, the calculator calculates a time of energy transfer with respect to a cycle of a driving signal as the duty ratio of energy transfer by receiving the driving signal for driving a converter switch and the time of energy transfer to the secondary side.

According to at least one embodiment, the reference signal for controlling the peak current output from the operator is compared with a primary-side sensing voltage signal, and the driving signal of the converter switch is generated according to the results of the comparison.

According to at least one embodiment, the isolated converter is a flyback converter.

In accordance with another embodiment of the invention, there is provided an isolated converter including a transformer including a primary-side winding, a secondary-side main winding, and a secondary-side auxiliary winding; a converter switch connected to the primary-side winding and switched to transfer a primary-side supply voltage to a secondary side through the transformer; an energy transfer time detector for detecting a time of energy transfer to the secondary side from the secondary-side auxiliary winding according to the switching of the converter switch; a circuit for generating a reference signal for controlling a peak current of the converter switch according to the embodiment of the invention discussed above; and a control block for generating and outputting a driving signal of the converter switch by comparing a primary-side sensing voltage signal with the reference signal for controlling the peak current generated by the circuit for generating a reference signal.

According to at least one embodiment, the circuit for generating a reference signal of the isolated converter further includes an AGC, which controls a gain of the dead-zone voltage signal output from the dead-zone generator to have a predetermined peak value and outputs the gain-controlled signal to the operator. Further, the operator of the circuit for generating a reference signal includes a multiplier for multiplying the duty ratio of energy transfer, which is calculated by the duty ratio calculator, by a predetermined gain to adjust a secondary-side output, and a divider for generating and outputting the reference signal for controlling the peak current by dividing an output signal of the AGC by an output of the multiplier.

According to at least one embodiment, the duty ratio calculator of the circuit for generating a reference signal calculates the time of energy transfer with respect to a cycle of the driving signal as an energy transfer duty ratio by receiving the driving signal for driving the converter switch and the time of energy transfer output from the energy transfer time detector.

According to at least one embodiment, the controller block includes a comparator for receiving and comparing the primary-side sensing voltage signal and the reference signal for controlling the peak current generated by the circuit for generating a reference signal, an on-time generator for determining an on operation time of the converter switch from a signal output from the secondary-side auxiliary winding, and a flip-flop for outputting the driving signal of the converter switch by receiving an output of the comparator and an output of the on-time generator.

According to at least one embodiment, the isolated converter further includes a voltage divider for dividing the primary-side supply voltage to provide the divided input voltage signal to a dead-zone generator, and a secondary output block including a rectifier diode connected to the secondary side of the transformer to rectify a secondary-side output and an output capacitor for charging a DC voltage rectified by the rectifier diode.

According to at least one embodiment, the isolated converter is a flyback converter.

In accordance with yet another embodiment of the invention, there is provided a method for generating a reference signal for controlling a peak current of a converter switch, which includes the steps of forming a dead-zone in an input voltage signal divided from a primary-side supply voltage of an isolated converter; calculating a duty ratio of energy transfer to a secondary side of the isolated converter; and generating a reference signal for controlling a peak current of a converter switch from a dead-zone voltage signal having the dead-zone using the duty ratio of energy transfer.

According to at least one embodiment, the method for generating a reference signal for controlling a peak current of a converter switch further includes a gain control step of generating and outputting the reference signal for controlling the peak current by controlling a gain of the dead-zone voltage signal having the dead-zone to have a predetermined peak value after the step of forming the dead-zone.

According to at least one embodiment, the step of generating and outputting the reference signal for controlling the peak current includes the steps of multiplying the duty ratio of energy transfer by a predetermined gain to adjust a secondary-side output, after the step of calculating the duty ratio of energy transfer, and generating the reference signal for controlling the peak current by dividing a gain-controlled output signal in the gain control step by an output in the step of multiplying the predetermined gain.

According to at least one embodiment, in the step of calculating the duty ratio of energy transfer, a time of energy transfer with respect to a cycle of a driving signal is calculated as the duty ratio of energy transfer by receiving the driving signal for driving the converter switch and the time of energy transfer to the secondary side.

According to at least one embodiment, in another example, the output reference signal for controlling the peak current is compared with a primary-side sensing voltage signal and the driving signal of the converter switch is generated according to the results of the comparison.

According to at least one embodiment, in an example, the isolated converter is a flyback converter.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a schematic block diagram of a circuit for generating a reference signal for controlling a peak current of a converter switch in accordance with an embodiment of the invention.

FIG. 2 is a schematic block diagram of a circuit for generating a reference signal for controlling a peak current of a converter switch in accordance with another embodiment of the invention.

FIG. 3 is a view schematically showing an isolated converter in accordance with another embodiment of the invention.

FIG. 4a is a view showing an energy transfer time according to a CRM operation of an isolated converter in accordance with another embodiment of the invention.

FIG. 4b is a view showing an energy transfer time according to a DCM operation of an isolated converter in accordance with another embodiment of the invention.

FIG. 5a is a graph showing a current supply waveform of an AC power supply when applying a comparative example in accordance with another embodiment of the invention.

FIG. 5b is a graph showing waveforms of an AGC output, a reference signal for controlling a peak current, an LED current, and an input current when applying an embodiment of the invention.

FIG. 6 is a graph schematically showing an input voltage signal detected by a voltage divider and a dead-zone voltage signal generated by a dead-zone generator in an embodiment of the invention.

FIG. 7 is a flowchart schematically showing a method for generating a reference signal for controlling a peak current of a converter switch in accordance with another embodiment of the invention.

FIG. 8 is a flowchart schematically showing a method for generating a reference signal for controlling a peak current of a converter switch in accordance with another embodiment of the invention.

FIG. 9 is a graph schematically showing a drain voltage and a MOSFET current in a converter switch of an isolated converter in accordance with another embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

First, a circuit for generating a reference signal for controlling a peak current of a converter switch in accordance with an embodiment of the invention will be described in detail with reference to the drawings. At this time, the reference numeral that is not mentioned in the reference drawing may be the reference numeral that represents the same element in another drawing.

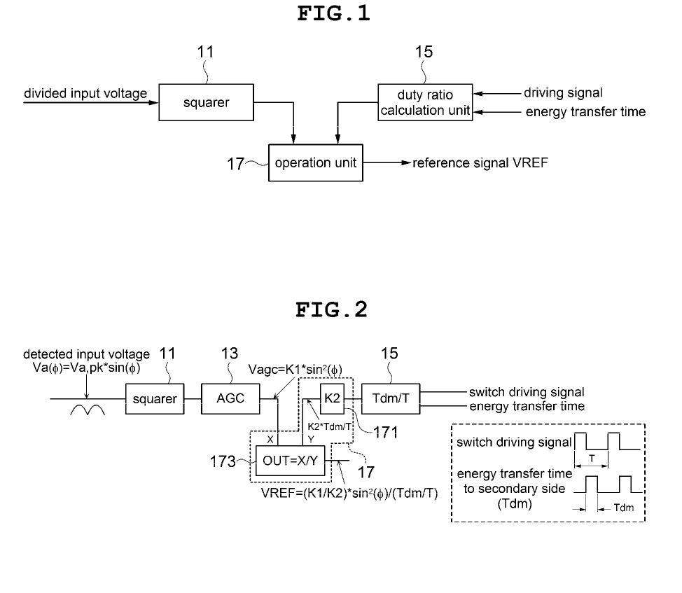

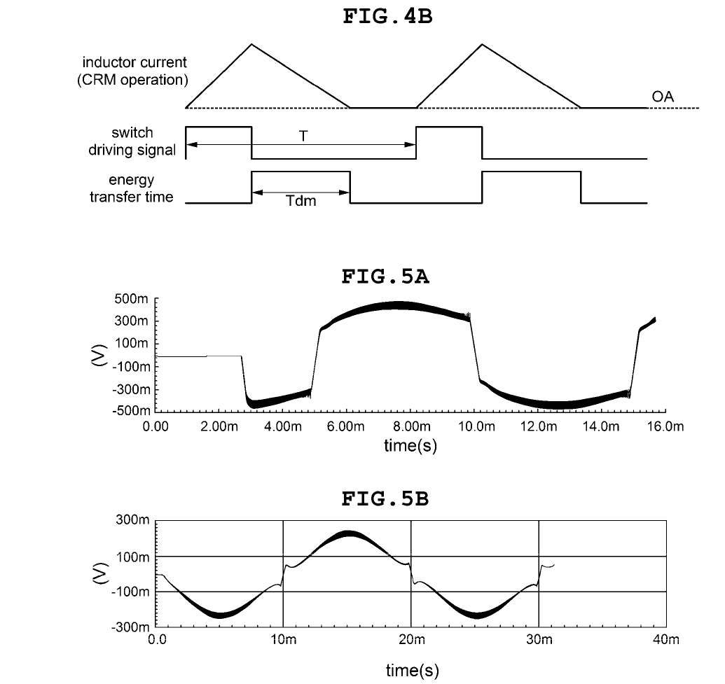

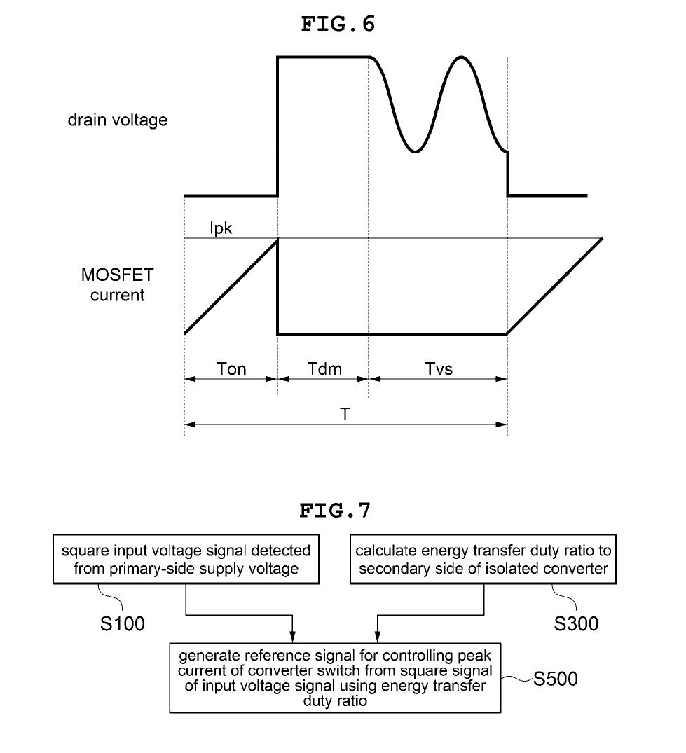

FIG. 1 is a schematic block diagram of a circuit for generating a reference signal for controlling a peak current of a converter switch in accordance with an embodiment of the invention, FIG. 2 is a schematic block diagram of a circuit for generating a reference signal for controlling a peak current of a converter switch in accordance with another embodiment of the invention, FIG. 4a is a view showing an energy transfer time according to a CRM operation of an isolated converter in accordance with another embodiment of the invention, FIG. 4b is a view showing an energy transfer time according to a DCM operation of an isolated converter in accordance with another embodiment of the invention, FIG. 5a is a graph showing a current supply waveform of an AC power supply when applying a comparative example in accordance with another embodiment of the invention, FIG. 5b is a graph showing waveforms of an AGC output, a reference signal for controlling a peak current, an LED current, and an input current when applying an embodiment of the invention, FIG. 6 is a graph schematically showing an input voltage signal detected by a voltage divider and a dead-zone voltage signal generated by a dead-zone generator in an embodiment of the invention, and FIG. 9 is a graph schematically showing a drain voltage and a MOSFET current in a converter switch of an isolated converter in accordance with another embodiment of the invention.

Referring to FIGS. 1 or/and 2, a circuit for generating a reference signal for controlling a peak current of a converter switch according to an example includes a dead-zone generator 11, a duty ratio calculator 15, and an operator 17. For example, referring to FIG. 2, the circuit for generating a reference signal for controlling a peak current of a converter switch further includes an AGC 13.

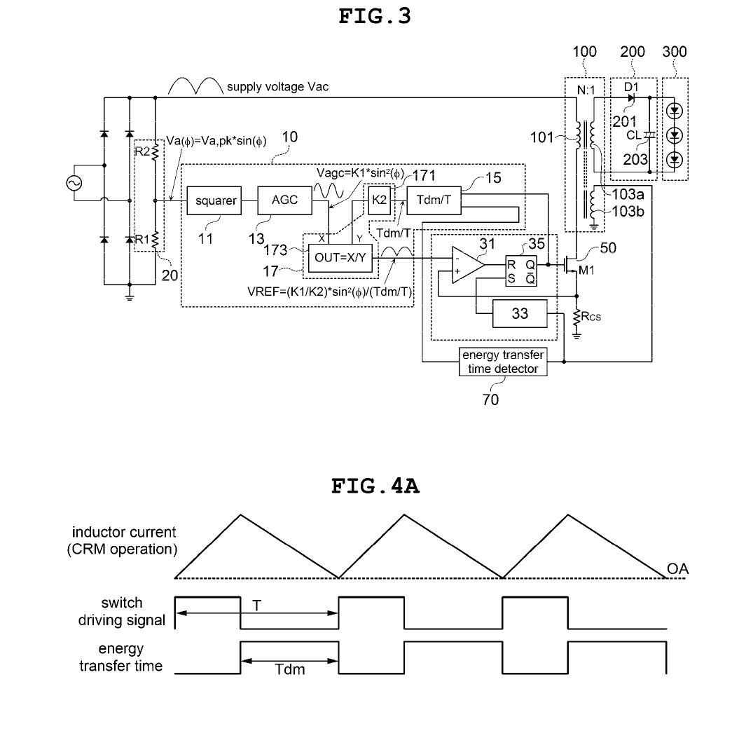

Referring to FIGS. 1 or/and 2, the dead-zone generator 11 generates a dead-zone voltage signal by forming a dead-zone in an input voltage signal divided or detected from a primary-side supply voltage of an isolated converter. Referring to FIG. 6, the input voltage signal divided or detected from the primary-side supply voltage of the isolated converter has a full-wave rectified sine wave form. Through the dead-zone generator 11, for example, in one cycle of the full-wave rectified sine wave, that is, in an interval of 0˜π, the dead-zone, where the phase has a zero value, is formed in the intervals of 0˜α and π−α˜π. Thus, the dead-zone voltage signal has a shape in which the dead-zone is formed in the intervals of 0˜α and π−α˜π of the full-wave rectified sine wave. For example, referring to FIG. 3, the dead-zone generator 11 is connected to a voltage divider 20, which provides the input voltage signal by dividing the primary-side supply voltage, and forms the dead-zone in the specific intervals, for example, in the intervals of 0˜α and π−α˜π by receiving or detecting the input voltage signal divided by the voltage divider 20. The dead-zone voltage signal having the dead-zone is used to generate a reference signal VREF for controlling a peak current in the operator 17, which will be described later, after being output from the dead-zone generator 11.

According to at least one embodiment, the isolated converter is a flyback converter. For example, the flyback converter operates in critical conduction mode (CRM) or discontinuous conduction mode (DCM). Thus, the dead-zone generator 11 forms the dead-zone and outputs the dead-zone voltage signal by receiving the input voltage signal divided from the primary-side supply voltage of the flyback converter, which operates in CRM or DCM.

For example, referring to FIGS. 2 or/and 3, in an example, the circuit for generating a reference signal for controlling a peak current of a converter switch further includes the AGC 13 between the dead-zone generator 11 and the operator 17. According to at least one embodiment, the AGC 13 controls a gain of the dead-zone voltage signal output from the dead-zone generator 11 to have a predetermined peak value K1 and outputs the gain-controlled signal to the operator 17.

Meanwhile, referring to FIGS. 1 or/and 2, the duty calculator 15 calculates a duty ratio of energy transfer (hereafter, referred to ‘the energy transfer duty ratio’) to a secondary side of the isolated converter.

According to at least one embodiment, the duty ratio calculator 15 receives a driving signal for driving a converter switch 50 and a time Tdm of an energy transfer (hereafter, referred to ‘the energy transfer time’) to the secondary side of the isolated converter and calculates the energy transfer time with respect to a cycle of the driving signal, thus, a switching cycle T as the energy transfer duty ratio Tdm/T. According to at least one embodiment, the energy transfer duty ratio Tdm/T means the energy transfer time Tdm to the secondary side with respect to the cycle of the driving signal, that is, the switching cycle T.

Next, referring to FIGS. 1 or/and 2, the operator 17 generates the reference signal VREF for controlling a peak current of the converter switch 50 from the dead-zone voltage signal having the dead-zone by using the energy transfer duty ratio Tdm/T calculated by the duty ratio calculator 15. According to at least one embodiment, the dead-zone voltage signal having the dead-zone is derived from the dead-zone generator 11. Thus, the operator 17 generates the reference signal for generation of the driving signal for controlling the converter switch.

For example, referring to FIG. 2, in an example, the operator 17 receives the gain-controlled dead-zone voltage signal by the peak value K1 from the AGC 13 and generates the reference signal for controlling the peak current of the converter switch 50 by using the energy transfer duty ratio Tdm/T.

Further, referring to FIG. 2, in an example, the operator 17 includes a multiplier 171 and a divider 173. According to at least one embodiment, the multiplier 171 multiplies the energy transfer duty ratio Tdm/T, which is calculated by the duty calculator 15, by a predetermined gain K2 to adjust a secondary-side output, for example, a current flowing to a secondary-side load 300 of FIG. 3. Further, the divider 173 generates and outputs the reference signal for controlling the peak current by dividing the output signal of the AGC 13 by the output of the multiplier 171.

According to at least one embodiment, referring to FIG. 3, in an example, the reference signal for controlling the peak current, which is output from the operator 17, is compared with a primary-side sensing voltage signal in a comparator 31 of a controller block 30. According to at least one embodiment, the driving signal of the converter switch 50 is generated according to the results of the comparison.

Next, the principle of the present invention will be described in detail. For example, the principles of the present invention will be described in detail by taking the case of an isolated converter applied to an LED driver.

According to at least one embodiment, an LED current in a flyback or buck-boost converter type LED driver, which operates in DCM or CRM is determined by a peak current Ipk flowing in a converter switch, for example, a MOSFET switch, a switching cycle T, and a current transfer time or an energy transfer time Tdm (demagnetizing time) to a secondary side. At this time, an LED current ILED of the secondary side is as the following Formula (1).

ILED=N/2·Ipk·(Tdm/T) Formula (1):

According to at least one embodiment, Tdm/T is a function of a power supply voltage, for example, a forward voltage drop VF of the LED. Therefore, ILED is a value that varies according to power and load if there is no special control.

However, if Ipk is controlled like Ipk∝T/Tdm, it is possible to suppress current fluctuations due to changes in Tdm/T.

If a supply voltage of the converter has an unrectified sine wave shape, it is possible to improve a power factor by including phase information of the power supply voltage in Ipk.

Ipk∝ sin(φ)·(T/Tdm)

In FIG. 6, a voltage of the converter switch 50, for example, a MOSFET switch and a current flowing in a MOSFET according to switching of the isolated converter are shown. When the converter switch 50 is turned on, the current flowing in the MOSFET, that is, an inductor current of the transformer is increased during a period of Ton. When the inductor current is increased to reach a set peak level Ipk, the converter switch 50 is turned off. When the converter switch 50 is turned off, the current is transferred to the secondary side during the energy transfer time to the secondary side, that is, during a period of Tdm. When all the energy is transferred to the secondary side, resonance due to parasitic devices (not shown) occurs until the converter switch 50 is turned on again.

According to at least one embodiment, a current supplied from an AC power supply of the isolated converter, that is, an AC input current Iin is calculated as the following Formula (2). At this time, ‘T’ is a driving signal cycle or a switching cycle of the converter switch.

Iin=½·Ipk·(Ton/T) Formula (2):

According to at least one embodiment, the input current is calculated on the assumption that a peak current of the converter switch is as the following Formula (3).

Ipk=K·sin(φ)(T/Tdm) Formula (3):

When calculating the input current using the above peak current formula of the converter switch, Iin=½·Ipk·(Ton/T)=½·K·sin(φ)(Ton/Tdm).

Assuming that a peak value of the power supply voltage is Vsup, for example, a forward voltage of the LED is VF, and a ratio of a primary-side winding Np and a secondary-side winding Ns of the transformer is N(=Np/Ns), Ton and Tdm is calculated as the following Formulas (4) and (5), respectively. According to at least one embodiment, the power supply voltage is typically used as a meaning of the primary-side supply voltage but is used as a meaning of an input power supply voltage of a front end of a bridge rectifier of FIG. 3.

Ton=Lm/(Vsup·sin(φ))·Ipk Formula (4):

Tdm=Lm/(N·VF)·Ipk Formula (5):

Therefore, the input current is as the following Formula (6).

Iin=½·Ipk(Ton/T)=½·K·sin(φ)(N·VF)/(Vsup·sin(φ))=½·K·(N·VF)/Vsup Formula (6):

According to at least one embodiment, if the input current is controlled ideally, the input current is always constant. Of course, the input current is not controlled perfectly like this, and an LED voltage varies according to the current size. At this time, the input current is not perfectly constant, but referring to FIG. 5a, the input current has an almost square wave shape and thus is significantly different from a sine wave shape. Thus, THD is reduced, resulting in a reduction in the power factor.

According to at least one embodiment, as a result of calculation of the input current on the assumption that the peak current of the converter switch is as the above Formula (3), the input current has an almost square wave shape as shown in FIG. 5a, resulting in the reduction in the THD and power factor.

According to at least one embodiment, the operation of the circuit for generating a reference signal for controlling a peak current of a converter switch using the dead-zone voltage signal proposed by embodiments of the invention will be described with reference to structures like FIGS. 2 and 3.

First, referring to FIG. 6, in embodiments of the invention, since the isolated converter is driven using the unrectified power supply voltage, the power supply voltage has a full-wave rectified sine wave shape when it is a primary-side supply voltage like a lower graph of FIG. 6.

Referring to FIGS. 2 and 3, for example, if the input voltage signal divided or detected by the voltage divider 20 is Va, the dead-zone voltage signal Va*, which is formed by adding the dead-zone to [0,α], [π−α,π] like the lower graph of FIG. 6, is generated. If the dead-zone voltage signal Va* is determined to have the peak value K1 through the AGC 13, an output voltage Vagc of the AGC 13 is as the following Formula (7).

$$Vagc = K 1 \cdot \frac{{Va}^{*} ( Φ )}{MAX [ {Va}^{*} ( Φ ) ]} \qquad Formula ( 7 )$$

MAX[Va*(φ)] means a maximum value of Va*. Vagc is mathematically expressed as the following Formula (8) by including the phase a that determines the dead-zone.

Vagc≧0, Vagc=K1·((1+A)sin(φ)−A)

Vagc<0, Vagc=0

sin(α)=A/(1+A) Formula (8):

The reference signal VREF for controlling a peak current that determines the peak current of the converter switch 50 is finally divided by K2*Tdm/T through the operation of the circuit 10 for generating a reference signal for controlling a peak current of a converter switch in FIGS. 2 and/or 3. Therefore, VREF has characteristics like the following Formula (9).

$$Vagc \geq 0 , VREF = \frac{K 1}{K 2} \cdot ( ( 1 + A ) sin ( Φ ) - A ) \cdot \frac{T}{{T}_{dm}} \qquad Formula ( 9 )$$

Vagc<0, VREF=0

sin(α)=A/(1+A)

Therefore, the peak current satisfies the following Formula (10). At this time, Rcs is a primary-side sensing resistor that detects the current flowing through the converter switch 50.

$$Vagc \geq 0 , Ipk = \frac{K 1}{K 2} \cdot \frac{( ( 1 + A ) sin ( Φ ) - A )}{Rcs} \cdot \frac{T}{{T}_{dm}} \qquad Formula ( 10 )$$

Vagc<0, Ipk=0

sin(α)=A/(1+A)

The secondary-side current, for example, the LED current ILED in the LED driving converter is calculated as the following Formula (11) using the above Formula (10).

$$Vagc \geq 0 , ILED = \frac{N}{2} \cdot Ipk \cdot \frac{{T}_{dm}}{T} = \frac{N}{2} \cdot \frac{K 1}{K 2} \cdot \frac{( ( 1 + A ) sin ( Φ ) - A )}{Rcs} \qquad Formula ( 11 )$$

Vagc<0, ILED=0

An LED average current ILED,avg is calculated as the following Formula (12) by integrating the interval of [0,π] from the above Formula (11). At this time, N is a winding ratio of the primary side and the secondary side of the transformer 100.

$$ILED , avg = M \cdot \frac{N}{4} \cdot \frac{1}{Rcs} , M = \frac{2 [ ( 1 + A ) cos ( {sin}^{- 1} \frac{A}{1 + A} ) - A ( \frac{π}{2} - 1 ) ]}{π} \qquad Formula ( 12 )$$

In the above Formula (12), if the angle α that determines the dead-zone is constant, A is constant by the following Formula (13).

$$A = \frac{sin α}{1 - sin α} \qquad Formula ( 13 )$$

Therefore, M is also a constant value. That is, since the LED average current ILED,avg is determined by constants such as M, N, and Rcs, the LED average current ILED,avg is maintained constant regardless of fluctuations of the power supply voltage and variations of the load to satisfy line regulation and load regulation characteristics. After all, it is possible to satisfy the regulation characteristics in spite of the addition of the dead-zone.

Next, a flyback LED driver is shown in FIG. 3 as an example of the isolated converter that is implemented by the method according to embodiments of the invention. Referring to FIG. 3, first, the full-wave rectified Vac signal is converted to Va using division resistors R1 and R2 of the voltage divider 20. The divided or detected input voltage signal Va generates the dead-zone voltage Va* through the dead-zone generator 11. The dead-zone voltage signal Va* is converted to the signal Vagc having a size of the maximum peak value K1 through the AGC 13. The cycle of the driving signal or the switching cycle T is obtained from a gate driving signal of the converter switch 50 and the energy transfer time Tdm is obtained from the output of a secondary-side auxiliary winding 103b by using an energy transfer time detector 70 so that a signal Tdm/T*K2 is obtained through the duty calculator 15 and the multiplier 171. The peak current control signal VREF of the converter switch 50 M1 is generated by dividing Vagc and Tdm/T*K2 using the divider 173.

Referring to FIG. 5a, a waveform of an AC input current, which is obtained through a simulation from a signal without a dead-zone by applying a comparative example without the dead-zone generator 11 shown in FIGS. 2 and 3, is shown. In FIG. 5a, since the waveform of the input current is suddenly changed near a zero-cross of the AC power supply, the total harmonic distortion (THD) is not good and the power factor (PF) is reduced. In the simulation, THD is almost 30% and PF is about 0.96.

However, as shown in FIG. 5b, according to an embodiment of the invention, when generating the reference signal VREF for controlling a peak current by forming the dead-zone, since the current near the zero-cross is almost 0 and gradually increased later, the THD of the input current is greatly improved.

FIG. 5b shows waveforms obtained from the results of a simulation when generating the reference signal VREF for controlling a peak current from the input voltage signal having the dead-zone according to an embodiment of the present invention. In FIG. 5b, the AGC output has the dead-zone, and the reference signal VREF for controlling a peak current also has a low value near the dead-zone. Therefore, the input current is almost 0 near the zero-cross of the power supply voltage Vac and gradually increased later. Therefore, the input current from the AC power supply has a shape similar to a sine wave as shown in FIG. 5b. In the simulation according to FIG. 5b, it is possible to obtain THD=16.3% and PF=0.98. Thus, it is possible to significantly improve the THD and PF through the control method proposed in an embodiment of the present invention.

Next, an isolated converter according to another embodiment of the invention will be described in detail with reference to the drawings. At this time, the circuits for generating a reference signal for controlling a peak current of a converter switch according to the above-described examples of the first aspect and FIGS. 1, 2, 4a, 4b, 5b and 6 will be referenced. Thus, repeated descriptions may be omitted.

FIG. 3 is a view schematically showing an isolated converter in accordance with another embodiment of the invention.

Referring to FIG. 3, an isolated converter according to an embodiment of the invention includes a transformer 100, a converter switch 50, an energy transfer time detector 70, a circuit 10 for generating a reference signal for controlling a peak current of a converter switch, and a controller block 30. Further, referring to FIG. 3, in an example, the isolated converter further includes a voltage divider 20.

According to at least one embodiment, the isolated converter is a flyback converter. For example, the flyback converter operates in CRM or DCM.

Referring to FIG. 3, the transformer 100 of the isolated converter includes a primary-side winding 101, a secondary-side main winding 103a, and a secondary-side auxiliary winding 103b. The transformer 100 transfers a primary-side supply voltage, which is input to the primary-side winding, to the secondary-side main winding 103a.

Next, referring to FIG. 3, the converter switch 50 of the isolated converter is connected to the primary-side winding 101 of the transformer 100 to perform a switching operation. At this time, according to the switching operation of the converter switch 50, the primary-side supply voltage is transferred to a secondary side through the transformer 100. That is, according to the switching operation of the converter switch 50, the transformer 100 transfers primary-side energy to the secondary side. At this time, referring to FIG. 4a, in case of CRM, an energy transfer time Tdm from the primary side to the secondary side is equal to an off interval of the converter switch 50. Further, referring to FIG. 4b, in case of DCM, the energy transfer time Tdm from the primary side to the secondary side is equal to an interval from an off time of the converter switch 50 to a point that an inductor current of the transformer 100 is ‘0’.

Next, referring to FIG. 3, the energy transfer time detector 70 detects the energy transfer time Tdm to the secondary side from the secondary-side auxiliary winding 103b of the transformer 100 according to the switching of the converter switch 50.

Next, the circuit 10 for generating a reference signal for controlling a peak current of a converter switch is one of the above-described embodiments according to the first aspect of the present invention. For example, referring to FIGS. 1, 2, or/and 3, the circuit 10 for generating a reference signal for controlling a peak current of a converter switch according to an example includes a dead-zone generator 11, a duty ratio calculator 15, and an operator 17.

According to at least one embodiment, the dead-zone generator 11 squares an input voltage signal divided from the primary-side supply voltage of the isolated converter. For example, referring to FIGS. 2 or/and 3, the dead-zone generator 11 receives or detects the input voltage signal divided from the primary-side supply voltage to square the input voltage signal.

According to at least one embodiment, the duty ratio calculator 15 calculates an energy transfer duty ratio Tdm/T to the secondary side of the isolated converter. According to at least one embodiment, in an example, the duty ratio calculator 15 of the circuit 10 for generating a reference signal for controlling a peak current of a converter switch receives a driving signal for driving the converter switch 50 and the energy transfer time output from the energy transfer time detector 70 to calculate the energy transfer time with respect to a cycle of the driving signal as the energy transfer duty ratio Tdm/T.

In addition, referring to FIGS. 1, 2, or/and 3, the operator 17 generates a reference signal for controlling a peak current of the converter switch 50 from a dead-zone voltage signal by using the energy transfer duty ratio Tdm/T calculated by the duty ratio calculator 15. For example, referring to FIGS. 2 or/and 3, the operator 17 receives the gain-controlled dead-zone voltage signal from an AGC 13 and generates the reference signal for controlling the peak current of the converter switch 50 by using the energy transfer duty ratio Tdm/T. For example, referring to FIGS. 2 or/and 3, the operator 17 includes a multiplier 171 and a divider 173. According to at least one embodiment, the multiplier 171 multiplies the energy transfer duty ratio Tdm/T, which is calculated by the duty ratio calculator 15, by a predetermined gain to adjust a secondary-side output, for example, a current flowing to a secondary-side load 300. Further, the divider 173 generates and outputs the reference signal for controlling the peak current by dividing the output signal of the AGC 13 by the output of the multiplier 171.

For example, referring to FIGS. 2 or/and 3, the circuit 10 for generating a reference signal for controlling a peak current of a converter switch further includes the AGC 13. At this time, the AGC 13 controls a gain of the dead-zone voltage signal, which is output from the dead-zone generator 11, to have a predetermined peak value and output the gain-controlled signal to the operator 17.

Next, the controller block 30 will be described in detail with reference to FIG. 3. The controller block 30 generates and outputs the driving signal of the converter switch 50 by comparing a primary-side sensing voltage signal and the reference signal for controlling the peak current, which is generated by the circuit 10 for generating a reference signal for controlling a peak current.

For example, referring to FIG. 3, in an example, the controller block 30 includes a comparator 31, an on-time generator 33, and a flip-flop 35. The comparator 31 of the control block 30 receives and compares the primary-side sensing voltage signal and the reference signal for controlling the peak current, which is generated by the circuit 10 for generating a reference signal for controlling a peak current. Further, the on-time generator 33 determines an on operation time of the converter switch 50 from the signal output from the secondary-side auxiliary winding 103b. Further, the flip-flop 35 outputs the driving signal of the converter switch 50 by receiving the output of the comparator 31 and the output of the on-time generator 33.

Further, the isolated converter according to at least one embodiment of the invention will be described with reference to FIG. 3. According to at least one embodiment, the isolated converter further includes the voltage divider 20. The voltage divider 20 divides the primary-side supply voltage and provides the divided input voltage signal to the squarer 11. Further, the isolated converter includes a secondary output block 200 including a rectifier diode 201 and an output capacitor 203. The rectifier diode 201 of the secondary output block 200 is connected to the secondary side of the transformer 100 to rectify the secondary-side output. The output capacitor 203 charges a DC voltage rectified by the rectifier diode 201.

According to at least one embodiment, referring to FIG. 3, when the isolated converter is an LED driving converter, the load 300, for example, an LED is connected to the secondary output block 200, specifically to the output capacitor 203.

Next, a method for generating a reference signal for controlling a peak current of a converter switch in accordance with another embodiment of the invention will be described in detail with reference to the drawings. According to at least one embodiment, the circuits for generating a reference signal for controlling a peak current of a converter switch according to the above-described examples of the first aspect and FIGS. 1 to 6 will be referenced. Thus, repeated descriptions may be omitted.

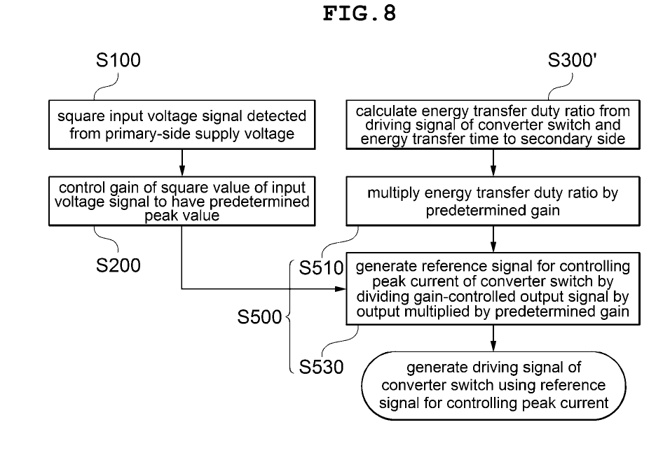

FIG. 7 is a flowchart schematically showing a method for generating a reference signal for controlling a peak current of a converter switch in accordance with another embodiment of the invention, and FIG. 8 is a flowchart schematically showing a method for generating a reference signal for controlling a peak current of a converter switch in accordance with another embodiment of the invention.

Referring to FIGS. 7 and/or 8, a method for generating a reference signal for controlling a peak current of a converter switch according to at least one embodiment of the invention includes an input voltage signal square step S100, an energy transfer duty ratio calculation step S300 and S300′, and a peak current control reference signal generation step S500 and S500′. Further, referring to FIG. 8, the method for generating a reference signal for controlling a peak current of a converter switch according to an example further includes a gain control step S200.

First, referring to FIGS. 7 and/or 8, in the input voltage signal square step S100, an input voltage signal divided from a primary-side supply voltage of an isolated converter is squared. For example, at this time, the isolated converter a flyback converter. Thus, the method for generating a reference signal for controlling a peak current of a converter switch according to at least one embodiment is applied to a flyback converter. For example, the method for generating a reference signal for controlling a peak current of a converter switch according to at least one embodiment is applied to a flyback converter that operates in CRM or DCM.

Further, referring to FIG. 8, in an example, the method for generating a reference signal for controlling a peak current of a converter switch according to at least one embodiment of the invention further includes the gain control step S200 before the peak current control reference signal generation step, specifically before the step S530 of FIG. 8 after the input voltage signal square step S100. In the gain control step S200, a gain of a dead-zone voltage signal is controlled to have a predetermined peak value and the gain-controlled signal is output to the peak current control reference signal generation step S530.

Next, referring to FIGS. 7 and/or 8, in the energy transfer duty ratio calculation step S300 and S300′, an energy transfer duty ratio Tdm/T to a secondary side of the isolated converter is calculated.

For example, in the energy transfer duty ratio calculation step S300 and S300′, a driving signal for driving a converter switch 50 and an energy transfer time to the secondary side are input and the energy transfer time with respect to a cycle of the driving signal is calculated as the energy transfer duty ratio Tdm/T. At this time, referring to FIG. 3, the driving signal for driving the converter switch 50 is a signal output from a controller block 30, specifically from a flip-flop 35, and the energy transfer time to the secondary side is obtained from an output signal of a secondary-side auxiliary winding 103b through an energy transfer time detector 70.

Continuously, referring to FIGS. 7 and/or 8, in the peak current control reference signal generation step S500 and S500′, a reference signal for controlling a peak current of the converter switch 50 is generated from the dead-zone voltage signal derived in the input voltage signal square step S100 by using the energy transfer duty ratio Tdm/T calculated in the energy transfer duty ratio calculation step S300 and S300′.

According to at least one embodiment, referring to FIG. 8, in an example, the peak current control reference signal generation step S500′ includes a gain multiplication step S510 and a peak current control reference signal generation step S530. According to at least one embodiment, in the gain multiplication step S510, after the energy transfer duty ratio calculation step S300′, the energy transfer duty ratio Tdm/T is multiplied by a predetermined gain K2 to adjust a secondary-side output. Thus, as the energy transfer duty ratio Tdm/T is multiplied by the predetermined gain K2 in the gain multiplication step S510, the secondary-side output, for example, a current flowing in a secondary-side load 300 of FIG. 3 is adjusted later. Continuously, referring to FIG. 8, in the peak current control reference signal generation step S530, the gain-controlled output signal in the gain control step S200 is divided by the output in the gain multiplication step S510, thus, in the step of multiplying a predetermined gain. According to at least one embodiment, the gain-controlled output signal is divided by the output multiplied by the predetermined gain K2 to generate the reference signal for controlling the peak current.

For example, at this time, referring to FIG. 3, in an example, the reference signal for controlling the peak current, which is output in the peak current control reference signal generation step S500 and S500′, is compared with a primary-side sensing voltage signal, and the driving signal of the converter switch 50 is generated according to the results of the comparison. At this time, referring to FIG. 3, the driving signal of the converter switch 50 is applied to a gate electrode of the converter switch 50 and transferred to a duty ratio calculator 15 at the same time so that the energy transfer duty ratio Tdm/T is calculated through the energy transfer duty ratio calculation step S300 and S300′.

As described above, the above-described embodiments perform control using primary-side sensing information without sensing and feeding back the secondary-side output in the isolated converter, for example, control the current of the converter switch 50 by adding the dead-zone to the input voltage signal divided or detected from the primary-side supply voltage and using the signal proportional to the dead-zone added signal.

According to at least one embodiment, for example, the isolated converter is a flyback converter, for example, a flyback converter that operates in CRM or DCM. According to at least one embodiment, the flyback converter is an LED driving converter. In the above-described embodiments of the present invention, it is possible to improve the THD and PF by controlling the current of the converter switch 50 by the signal proportional to the dead-zone voltage signal having the dead-zone using the primary-side sensing information, not the secondary-side sensing information. Further, when applied to the LED driving converter, it is possible to satisfy the line regulation and load regulation characteristics.

According to an embodiment of the present invention, it is possible to control the peak current of the converter switch using the primary-side sensing information without sensing and feeding back the secondary-side output in the isolated converter. For example, it is possible to control the peak current of the converter switch by adding the dead-zone to the input voltage signal divided or detected from the primary-side supply voltage and using the signal proportional to the dead-zone added signal. Accordingly, it is possible to improve the THD and the power factor. Further, for example, when applied to the LED driving converter, it is possible to satisfy the line regulation and load regulation characteristics.

Further, according to an embodiment of the present invention, it is possible to control the secondary-side average current regardless of the variations of the load and the fluctuations of the power supply voltage by generating the reference signal for controlling the peak current of the converter switch to control the peak current of the converter switch. Accordingly, it is possible to expect the following effects.

First, it is possible to improve the line regulation. Thus, it is possible to satisfy the constant secondary-side current, for example, the LED current in spite of the fluctuations of the power supply voltage. Second, it is possible to improve the load regulation. Thus, it is possible to satisfy the constant secondary-side current, for example, the LED current in spite of the changes in the characteristics of the load. Third, it is possible to improve the THD. Thus, it is possible to improve the THD since the input current supplied from the AC power supply has a sine wave shape. Fourth, it is possible to improve the PF. Thus, it is possible to improve the PF since the current supplied from the AC power supply is equal to the phase of the power supply voltage and the harmonics of the current are suppressed.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A circuit for generating a reference signal for controlling a peak current of a converter switch, the circuit comprising:
a dead-zone generator configured to form a dead-zone in an input voltage signal divided from a primary-side supply voltage of an isolated converter;
a duty ratio calculator configured to calculate a duty ratio of energy transfer to a secondary side; and
an operator configured to generate and output a reference signal for controlling the peak current of the converter switch from a dead-zone voltage signal having the dead-zone using the duty ratio of energy transfer calculated by the duty ratio calculator.

2. The circuit for generating the reference signal for controlling the peak current of the converter switch according to claim 1, further comprising:
an automatic gain controller (AGC) configured to control a gain of the dead-zone voltage signal output from the dead-zone generator to have a predetermined peak value and to output the gain-controlled signal to the operator.

3. The circuit for generating the reference signal for controlling the peak current of the converter switch according to claim 2, wherein the operator comprises:
a multiplier configured to multiply the duty ratio of energy transfer, which is calculated by the duty ratio calculator, by a predetermined gain to adjust a secondary-side output; and
a divider configured to generate and output the reference signal for controlling the peak current by dividing an output signal of the AGC by an output of the multiplier.

4. The circuit for generating the reference signal for controlling the peak current of the converter switch according to claim 1, wherein the duty ratio calculator is configured to calculate a time of energy transfer with respect to a cycle of a driving signal as the duty ratio of energy transfer by receiving the driving signal for driving a converter switch and the time of energy transfer to the secondary side.

5. The circuit for generating the reference signal for controlling the peak current of the converter switch according to claim 3, wherein the duty ratio calculator is configured to calculate a time of energy transfer with respect to a cycle of a driving signal as the duty ratio of energy transfer by receiving the driving signal for driving a converter switch and the time of energy transfer to the secondary side.

6. The circuit for generating the reference signal for controlling the peak current of the converter switch according to claim 4, wherein the reference signal for controlling the peak current output from the operator is compared with a primary-side sensing voltage signal, and the driving signal of the converter switch is generated according to the results of the comparison.

7. The circuit for generating the reference signal for controlling the peak current of the converter switch according to claim 4, wherein the isolated converter is a flyback converter.

8. An isolated converter, comprising:
a transformer comprising a primary-side winding, a secondary-side main winding, and a secondary-side auxiliary winding;
a converter switch connected to the primary-side winding and switched to transfer a primary-side supply voltage to a secondary side through the transformer;
an energy transfer time detector configured to detect a time of energy transfer to the secondary side from the secondary-side auxiliary winding according to the switching of the converter switch;
a circuit configured to generate a reference signal for controlling a peak current of the converter switch according to claim 1; and
a controller block configured to generate and output a driving signal of the converter switch by comparing a primary-side sensing voltage signal with the reference signal for controlling the peak current generated by the circuit for generating a reference signal.

9. The isolated converter according to claim 8, wherein the circuit for generating a reference signal further comprises an automatic gain controller (AGC) configured to control a gain of the dead-zone voltage signal output from the dead-zone generator to have a predetermined peak value and to output the gain-controlled signal to the operator, and
the operator of the circuit configured to generate the reference signal comprises:
a multiplier configured to multiply the duty ratio of energy transfer, which is calculated by a duty ratio calculator, by a predetermined gain to adjust a secondary-side output; and
a divider configured to generate and output the reference signal for controlling the peak current by dividing an output signal of the AGC by an output of the multiplier.

10. The isolated converter according to claim 8, wherein the duty ratio calculator of the circuit configured to generate the reference signal is further configured to calculate the time of energy transfer with respect to a cycle of the driving signal as an energy transfer duty ratio by receiving the driving signal for driving the converter switch and the time of energy transfer output from the energy transfer time detector.

11. The isolated converter according to claim 8, wherein the controller block comprises:
a comparator configured to receive and compare the primary-side sensing voltage signal and the reference signal for controlling the peak current generated by the circuit for generating the reference signal;
an on-time generator configured to determine an on operation time of the converter switch from a signal output from the secondary-side auxiliary winding; and
a flip-flop configured to output the driving signal of the converter switch by receiving an output of the comparator and an output of the on-time generator.

12. The isolated converter according to claim 8, further comprising:
a voltage divider configured to divide the primary-side supply voltage to provide the divided input voltage signal to the dead-zone generator; and
a secondary output block comprising a rectifier diode connected to the secondary side of the transformer to rectify a secondary-side output and an output capacitor for charging a DC voltage rectified by the rectifier diode.

13. The isolated converter according to claim 8, wherein the isolated converter is a flyback converter.

14. A method for generating a reference signal for controlling a peak current of a converter switch, the method comprising:
forming a dead-zone in an input voltage signal divided from a primary-side supply voltage of an isolated converter;
calculating a duty ratio of energy transfer to a secondary side of the isolated converter; and
generating the reference signal for controlling the peak current of the converter switch from a dead-zone voltage signal having the dead-zone using the duty ratio of energy transfer.

15. The method for generating a reference signal for controlling a peak current of a converter switch according to claim 14, further comprising,
after forming the dead-zone, a gain control step of generating and outputting the reference signal for controlling the peak current by controlling a gain of the dead-zone voltage signal having the dead-zone to have a predetermined peak value.

16. The method for generating a reference signal for controlling a peak current of a converter switch according to claim 15, wherein generating and outputting the reference signal for controlling the peak current comprises,
multiplying the duty ratio of energy transfer by a predetermined gain to adjust a secondary-side output after calculating the duty ratio of energy transfer; and
generating the reference signal for controlling the peak current by dividing a gain-controlled output signal in the gain control step by an output in the step of multiplying the predetermined gain.

17. The method for generating a reference signal for controlling a peak current of a converter switch according to claim 14, wherein in calculating the duty ratio of energy transfer, a time of energy transfer with respect to a cycle of a driving signal is calculated as the duty ratio of energy transfer by receiving the driving signal for driving the converter switch and the time of energy transfer to the secondary-side.

18. The method for generating a reference signal for controlling a peak current of a converter switch according to claim 16, wherein in calculating the duty ratio of energy transfer, a time of energy transfer with respect to a cycle of a driving signal is calculated as the duty ratio of energy transfer by receiving the driving signal for driving the converter switch and the time of energy transfer to the secondary-side.

19. The method for generating a reference signal for controlling a peak current of a converter switch according to claim 17, wherein the output reference signal for controlling the peak current is compared with a primary-side sensing voltage signal and the driving signal of the converter switch is generated according to the results of the comparison.

20. The method for generating a reference signal for controlling a peak current of a converter switch according to claim 17, wherein the isolated converter is a flyback converter.
